(19) United States
(12) Patent Application Publication
(10) Pub. No.: US 2026/0291749 A1
(43) Pub. Date: Sep. 24, 2026

(54) AN AUTHENTICATION PROTOCOL FOR ESTABLISHING A MOMENTARY TRUST ZONE DURING A LOGIN AND OPERATION PROCEDURE

(71) Applicant: Yong Kwang FOO, Masai, Johor (MY)

(72) Inventor: Yong Kwang FOO, Masai, Johor (MY)

(21) Appl. No.: 19/472,510

(22) PCT Filed: Apr. 2, 2024
(86) PCT No.: PCT/MY2024/050032

§ 371 Date: Oct. 3, 2025

(30) Foreign Application Priority Data
Apr. 3, 2023 (SG) 10202300911W

(51) Int. Cl. H04L 9/32; H04L 9/08

(52) U.S. Cl. CPC H04L 9/3247; H04L 9/0866; H04L 9/3263; H04L 2209/72

(57) ABSTRACT

The present invention discloses an authentication protocol for establishing a momentary trust zone during a login and operation procedure. The protocol involves a user interface (20) which interacts with a user, a personal cryptographic key generator (10) which can be activated by the user to generate ephemeral keys and/or sign credentials, a cryptographic processor (30) which is embedded within the user interface to challenge and verify the authenticity of the user interface (20), and a verification processor (40) which is embedded within service provider servers to verify processed data received from the cryptographic processor (30). The personal cryptographic key generator (10) can be further characterised by (a) operating entirely in an offline mode with the exception of a single instance where it (10) is switched to an online mode to transmit the generated ephemeral keys and/or the signed credentials, and after which it switches back to the offline mode, and (b) operating in an unbalance communication mode where the personal cryptographic key generator (10) exclusively initiates and/or disconnects a data transfer link to a device which the user interface (20) is operated thereon.

### FIELD OF INVENTION

The invention relates to network security at the point of contact and access by human to digital system which includes both hardware and software. More particularly, the invention relates to the use of a personal cryptographic key generator as a root key to a series of cascading cryptographic authentication operations to establish a momentary trusted group of hardware and software during a login and operation procedure.

### BACKGROUND OF THE INVENTION

According to various cybersecurity reports, the user login processing channel remains a common entry point for hackers, with estimates ranging from 60-80% of attacks involving compromised passwords or credentials. This suggests that login attacks are a significant entry point for attackers.

Other methods of attack may include network-based attacks such as phishing, malware, or other types of exploits, as well as email attacks that trick users into clicking on malicious links or downloading infected attachments. USB-based attacks can also be a potential threat if an attacker gains physical access to a system or device and is able to plug in a USB drive that contains malware.

A wide arsenal of tools (predominantly software-based) and methods exits and are deployed to mitigate the above threats. Ironically, even these software-based tools have a similar user login process. Thus, they are exposed to similar threats and are as vulnerable as the systems they are designed and deployed to protect.

Therefore, when these systems that are protecting the protected systems are compromised but undetected, Zero-trust architecture has become an increasingly popular framework for securing systems and networks. The idea behind zero trust is simple: rather than assuming that all components within a system are trustworthy, the system should assume that no component can be trusted until proven otherwise. This means that every component, including applications, devices, and users, must be repeatedly verified and authenticated before being granted access to resources or executing functions of process. However, current tools that configure and enforce Zero Trust operations are software based too, hence have similar vulnerabilities.

### CURRENT COMPUTING AND NETWORKING DOMAIN

The relationship between devices in the systems and networks are commonly based on client-server architecture used in current prevalent computer networking and distributed computing. In this model, a central server provides resources or services to multiple clients that connect to it over a network. In a client-server reference model, there are typically two main components:
A) The client, which is a program or application overlaid by User Interface (UI) and User Experience (UX) that runs on the user's device (e.g. computer, smartphone, or tablet) and sends requests to the server. The User Interface (UI) refers to the visual and interactive aspects of an application or website that users interact with directly. It includes elements such as buttons, menus, text fields, and graphics, as well as the layout, typography, and color scheme of the user interface. For example, the login screen presented to the User with fields to key in required information such as login ID and password. The User Experience (UX) refers to the overall experience that a user has when interacting with an application or website, including how easy it is to use, how efficient it is, and how enjoyable it is. UX design focuses on the user's needs, goals, and behaviour to create an interface that is intuitive, efficient, and satisfying to use. In other words, UI design is focused on creating an attractive and functional visual interface that users can interact with, while UX design is focused on creating an experience that meets the user's needs and goals. These software runs on the device operating systems and communication functions.

B) The server, which is a program or application that runs on a central computer or network device and responds to client requests by providing data, resources, or services. These components are connected by a network, such as the internet or a local area network (LAN). When the client needs to access a resource or service provided by the server, it sends a request over the network to the server. The server processes the request and sends a response back to the client. The client and server can be on different physical machines, and the server may handle requests from multiple clients simultaneously. This allows for efficient resource sharing and scalability in large-scale systems.

The operation of the client-server model can be described as follows:
1. A client application running on a user's device (e.g. a computer, tablet, or smartphone) initiates a connection to a server application over a network.
2. The server application listens for incoming connections from clients and accepts the connection request from the client.
3. Once the connection is established, the client sends a request to the server to perform a specific action, such as retrieving data or executing a function.
4. The server receives the request and processes it, using its available resources to generate a response.
5. The server sends the response back to the client over the network.
6. The client receives the response and takes the appropriate action based on the information received.
7. If necessary, the client may send additional requests to the server to complete a task or obtain more information.
8. Once the client is done with the server, it closes the connection.

The client-server model is used in a wide range of applications, such as web servers, email servers, database servers, and game servers that constitutes the foundation of Digital Domain. It allows for efficient resource sharing and provides a scalable architecture that can accommodate large numbers of clients that serves the users (Humans).

Log in page which is part of login process is normally the first User's touchpoint with the Digital Domain. The system login process typically involves the following steps:
1. The user navigates to the login page of the system they want to access.
2. The user enters their username or email address and password into the appropriate fields on the login page.
3. The system checks the entered credentials against its database of authorized users to ensure that they are valid and match an existing user account.
4. If the credentials are valid, the system grants access to the user and directs them to the appropriate user interface. If the credentials are invalid, the system displays an error message and prompts the user to re-enter their credentials.
5. Depending on the system's security settings, the user may be prompted to provide additional authentication factors, such as a security question, biometric authentication (e.g. fingerprint, facial recognition), or a one-time code sent to their mobile device.
6. Once the user is authenticated and authorized, they can access the features and functions of the system based on their permissions and privileges.

It's worth noting that the login process may vary slightly depending on the system and its security policies. Some systems may also include additional steps or require specific authentication methods to ensure a high level of security.

However, despite this robust approach to security, there is still two common points of weakness that hackers can exploit: the human factor plus the more sophisticated UI/UX provides larger surface of attack. Whether it's through human weakness exploited by social engineering or malware installed within UI/UX operating with more complex local, remote cloud-based servers and security tools before and after deployment, Therefore, the weakest link in any security system is often the user, particularly during login. The problem is that every security system has the same common point of vulnerability: the login process. As a result, even the most secure systems are only as strong as their weakest link, in particular, this weak link. The current method, mainly user focused, identity and authentication methods of managing passwords and access controls relies on software-based systems that can themselves be hacked, thus, making it difficult to trust them to perform their role of protecting systems against software-based threats.

To strengthened User identity authentication, most financial related operation added the use of one-time passwords (OTPs). OTPs are unique codes generated for a single use are utilized as additional authentication of users when accessing a system or network. OTPs can be sent via SMS, email, or generated using mobile applications. While OTP is considered as a stronger authentication method than static password, they are not completely immune to vulnerabilities. Various techniques exist frequently used by cybercriminals to remotely intercept, retrieve or acquire OTPs sent through SMS or email if these channels are not secure. For example: like any other security mechanism, OTPs are not fool proof and can be vulnerable to different types of attacks. Here are some examples of OTP hacks:
1. Social engineering: Attackers can trick the user into revealing the OTP by phishing or other social engineering techniques. For example, an attacker may send an email or SMS claiming to be from the user's bank or other trusted organization, and ask the user provide the OTP for verification.
2. Man-in-the-middle attack: In a man-in-the-middle attack, the attacker intercepts the communication between the user and the server and can steal the OTP. This can be done by intercepting the SMS containing the OTP or by using a fake login page to capture the OTP entered by the user.
3. Brute force attack: A brute force attack is a trial-and-error method in which the attacker tries all possible combinations of the OTP until the correct one is found. This is difficult to do if the OTP has a long and complex combination of numbers, letters, and symbols.
4. OTP interception: An attacker can use malware or other techniques to intercept the OTP as it is generated on the user's device. This can be done by infecting the user's device with malware or by exploiting vulnerabilities in the device or the OTP generation process.
5. Pretexting: Pretexting involves the attacker impersonating the user or a trusted entity and requesting the OTP from the service provider. This can be done by using stolen credentials or other information to convince the service provider to provide the OTP.

The interception of OTPs can lead to severe consequences for the victim, as cybercriminals can assume easy access passage because all those institutions that implemented OTP as THE final and decisive step of User authentication, they can gain unauthorized access to sensitive information or systems or services that require authentication. This access can result in a wide range of issues, including financial losses, data breaches, identity theft, operational disruption, loss of data integrity and other forms of cybercrime. For instance, if a cybercriminal intercepts an OTP used to authenticate online banking transactions, they can potentially make fraudulent transactions using the victim's account, leading to financial losses for the victim. Similarly, if the OTP is used to access confidential business information, the interception can lead to corporate espionage, loss of intellectual property, and damage to the organization's reputation. Moreover, cybercriminals can use the intercepted OTP to steal personal information, such as social security numbers, credit card numbers, and other sensitive information. This information can be used for identity theft, which can lead to long-lasting financial and legal consequences for the victim. In some cases, cybercriminals may even use the intercepted OTP to gain control of the victim's device or system, enabling them to conduct further attacks or to install malware that can cause even more damage.

Therefore, by adding another layer of authentication that is already hacked by many methods over the weak static password authentication method and regarded as the final pass have to be seriously reconsidered.

There are several alternative security methods to OTPs that can be used to protect sensitive information and prevent unauthorized access. One of them is biometric authentication, where a user's biometric data collected from their smartphone is compared to a template stored either on the mobile device or a cloud server. While biometric authentication on smartphones or servers offers several advantages, including convenience and enhanced security, it also has some drawbacks that need to be carefully considered. The potential risks of using biometric authentication on smartphones or servers include the multipurpose nature of smartphones that can prompt hacking and the transmission of biometric data over insecure networks that can be intercepted.

A similar method of the biometric authentication can be found in US20030139984A1. This Patent discloses a system and method that enables cashless and clerkless transactions to purchase a wide variety of products. The system is made up of four key functional components, including a point-of-sale terminal, identification devices, databases, and a network to link them. To carry out a cashless and clerkless transaction, the system collects information about the product, personal details, and biometric information of the individual who wants to buy the product. This captured biometric information is matched against stored biometric data to verify the buyer's identity. If the buyer's identity is confirmed, the system permits the sale transaction and updates inventory and financial databases accordingly. Additionally, the system can be used to confirm that the customer has legitimately purchased merchandise as they exit the store.

Nevertheless, the biometric templates are stored on the server which leads to a potential loop hole where the transmission of biometric information can be intercepted by cybercriminals if the network is not secure and compromising the user's biometric data. If the biometric data is stolen, it cannot be easily changed like a password, making it a significant risk for users. Furthermore, Biometric data is considered sensitive personal information and is subject to data privacy regulations, such as the Personal Data Protection Act (PDPA) in some countries. The PDPA outlines strict guidelines for the collection, use, and disclosure of personal data, including biometric data. Therefore, any company or organization that collects, uses, or stores biometric data on a server must ensure that they comply with the PDPA or similar data privacy regulations to protect the privacy and security of their customers' personal information. Failure to do so can result in severe legal and financial consequences, as well as damage to the company's reputation.

To address these challenges, a new approach is needed that derives the security protocol based on Zero Trust of all related operating entities, that use dedicated hardware without operating system and normally offline and only online to transmit its generated ephemeral key as the root key for series of cascading authentication operations between neighbouring entities(hardware, software) resulting in Zero Knowledge Proof operation of User authentication without any subsequent need of key storage or recovery, hence reduce to the space for hacks via social engineering that exploit human weakness to the minimum. This hardware-rooted authentication protocol provides a stronger layer of protection against unauthorized access and breaches without any further reading or keying in of any secret codes by the User. By moving away from layers of software only-based security operations, organizations can better protect their systems and networks from attacks that exploit the human factor. This invention provides such a method and system thereof.

### SUMMARY OF INVENTION

In one aspect of the invention, there is provided a computer implementable protocol for establishing a momentary trust zone as part of a login and operation procedure. The login and operation procedure includes a user onboarding process, a user login process, and an operation process. The protocol, during a user login process, comprising the steps of: receiving, by a user interface, login credential of a user to initiate the login process; instructing, by the user interface, the user to activate a personal cryptographic key generator; performing, by the personal cryptographic key generator, an ephemeral key generation and/or credentials signing upon activation by the user; transmitting, by the personal cryptographic key generator, the newly generated ephemeral keys and/or signed credentials to a cryptographic processor which is embedded within the user interface; processing, by the cryptographic processor, data received from the user interface and the personal cryptographic key generator; and transmitting, by the cryptographic processor, the processed data to a verification processor which is embedded within the service provider servers; whereby the momentary trust zone is established when the processed data is authenticated and verified by a verification processor which is embedded within the servers; wherein the personal cryptographic key generator is a wireless device without operating system configured to: (a) operate entirely in an offline mode with the exception of a single instance where the personal cryptographic key generator is switched to an online mode to transmit the generated ephemeral keys and/or the signed credentials, and after which it switches back to the offline mode; and (b) operate in an unbalance communication mode where the personal cryptographic key generator exclusively initiates and/or disconnects a data transfer link to a device which the user interface is operated thereon; and wherein the cryptographic processor is configured to (a) perform an encryption and/or decryption on the received data to ensure data confidentiality, (b) perform a data integrity checking algorithm on the received data, and (c) perform signatures signing on the user interface credential for the service provider server to authenticate the user interface.

Preferably, the protocol, during the user onboarding process, may comprise the steps of: retrieving, by the cryptographic processor, a signed certificate from a certificate authority server; receiving, by the user interface, a unique identity of the personal cryptographic key generator to verify with a device registry server; registering, by the cryptographic processor, the service provider servers' signed credential verification key; instructing, by the user interface, the user to activate the personal cryptographic key generator; performing, by the personal cryptographic key generator, an ephemeral key generation and/or credentials signing upon activation by the user; transmitting, by the personal cryptographic key generator, the generated ephemeral keys and/or signed credentials to the cryptographic processor; forwarding, by the cryptographic processor, a verification key of the personal cryptographic key generator to the verification processor; and binding, by the verification processor, the verification key with the user's profiles.

Preferably, the protocol, during the operation process, may comprise the steps of: providing, by the user interface, functional options for the user to select and execute upon successful establishment of the momentary trusted zone; instructing, by the cryptographic processor, the user interface to request for activating the personal cryptographic key generator upon receiving one or more instruction messages of the function options which required signatures from the user interface; instructing, by the user interface, the user to activate the personal cryptographic key generator; performing, by the personal cryptographic key generator, an ephemeral key generation and/or credentials signing upon activation by the user; transmitting, by the personal cryptographic key generator, the newly generated ephemeral keys and/or signed credentials to the cryptographic processor; performing, by the cryptographic processor, signature signing on the instruction messages; and transmitting, by the cryptographic processor, the signed instruction messages, the signature, and a newly generated verification key to the service provider servers.

Preferably, the personal cryptographic key generator may comprise a physical isolation arrangement for protecting it physically against unauthorised access and a counterparty cryptography processor to establish the data transfer link in a secure fashion via one or more cryptographic protocols.

Preferably, the personal cryptographic key generator may comprise a notifier to provide a notification of a current operation status.

Preferably, the personal cryptographic key generator may comprise one or more input means for receiving input data from a user.

Preferably, the one or more input means can be in the form of one or more biometric sensors for capturing biometric traits of a user and a processor for verifying an identity of the user using a template-free biometric authentication method, whereby the ephemeral keys and credentials are respectively generated and signed upon successful verification of the user.

Preferably, the generated ephemeral keys and/or signed credentials can be of a predetermined structure and size for them to be transmitted in a consistent and secure manner.

Preferably, the credential can be signed using one or more hashing algorithms and signing algorithms.
10. The computer implementable protocol according to any one of claims 2 to 9, wherein the personal cryptographic key generator comprises a QR code that contains the unique identity of the personal cryptographic key generator, and the unique identity is retrievable through scanning the QR code.
11. The computer implementable protocol according to any one of claims 3 to 10, wherein cryptographic processor is configured to perform a cascading signature operation that signs a batch of instruction messages.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a schematic diagram illustrating a general architecture of a system for establishing a momentary trusted zone during a login and operation procedure.

FIG. 2 is a schematic diagram illustrating a user onboarding process.

FIG. 3 is a schematic diagram illustrating a user login process.

FIG. 4 is a schematic diagram illustrating an operation process.

### DETAILED DESCRIPTION OF THE INVENTION

It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, that execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions/acts specified in the flowchart and/or block diagram block or blocks.

The invention will now be described in greater detail, by way of example, with reference to the drawings.

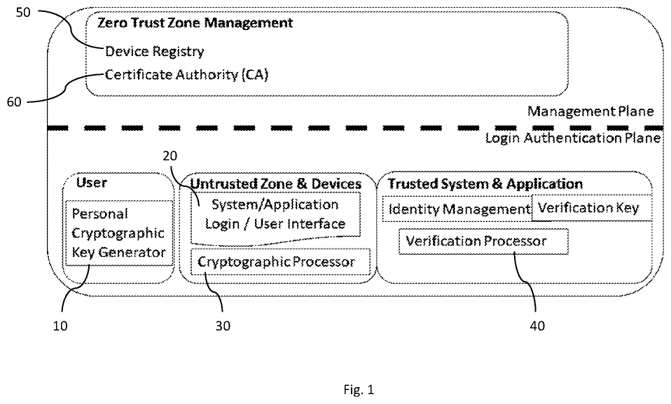

Referring to FIG. 1, A system for establishing a momentary trust zone as part of a login and operation procedure is illustrated. The system can be divided into two planes, namely the management plane and the login authentication plane. A device registry server 50 and a certificate authority server 60 are part of the management plane and are preferably being managed under a zero-trust zone environment. By managing these servers in the zero-trust environment, an access to these servers 50, 60 is restricted, and all attempts to access them are subject to strict authentication and authorization procedures. Additionally, any communication with these servers 50, 60 is encrypted to ensure the confidentiality of the data being transmitted. Under the login authentication plane, the components can be divided into a user end, an untrusted zone and trusted zone. The user end comprises a personal cryptographic key generator 10, the untrust zone comprises a user interface 20 with a cryptographic processor 30 embedded therewithin, and the trusted zone comprises one or more service provider servers with a user database and a verification processor 40 embedded therewithin.

The personal cryptographic key generator 10 is a physical device that can be easily carried around with and safely kept by the user. Preferably, the personal cryptographic key generator 10 has zero software and all functions of the personal cryptographic key generator 10 are carried out by dedicated hardware modules so that malwares cannot be deposited into the personal cryptographic key generator 10. As a result, the risk of malware or other software-based attacks can be prevented. The personal cryptographic key generator 10 can take various forms including but is not limited to physical token device, smart cards or any personal objects which can be embedded with integrated circuits. By way of example, the personal cryptographic key generator 10 can be provided with a casing that has a physical isolation arrangement for protecting it physically against unauthorised access. A QR code can be printed on an exposing surface of the personal cryptographic key generator 10. Such QR code contains a unique identity of the personal cryptographic key generator 10, and the unique identity is retrievable through scanning the QR code. Alternatively, the personal cryptographic key generator 10 can be provided with a notifier to provide a notification of a current operation status. Such notification may include but is not limited to audio notification, visual notification, tactile notification and dashboard notification.

The personal cryptographic key generator 10 is designed specifically to generate ephemeral keys and sign credentials. The ephemeral keys are cryptographic keys that are generated for a short period of time and then discarded or destroyed. Since these keys are only used for a short period of time, even if they are intercepted, they cannot be used to decrypt data from other sessions or messages. Preferably, the ephemeral keys may include a signature key and a verification key. The signature key can be used to digitally sign credentials or messages for ensuring that the credentials or messages have not been tampered with during transmission. The verification key can then be used to check the integrity of the signed credentials or messages so as to ensure that the signed credentials or messages were not modified or forged. The generated ephemeral keys and signed credentials are configured to be transmitted in a consistent and secure manner, with a predetermined structure and size. This is important for ensuring that the keys and credentials can be transmitted and processed efficiently, and that they cannot be intercepted or modified by an attacker during transmission.

In the process of credential signing, the credentials are first hashed to create a unique and irreversible string of characters. These hashed credentials are then encrypted to protect it from unauthorized access, and the resulting encrypted string is signed by a trusted authority to provide additional authentication and verification. By using this combination of hashing, encryption, and signed credentials, the system can ensure that only authorized users are granted access to the signed credential. The hashed and encrypted signed credential acts as the foundation or root of the authentication process, providing a secure and reliable method for verifying the identity of the user.

The personal cryptographic key generator 10 is provided with a transmission module that establish a data transfer link with a device which the user interface is operated thereon. Specifically, the personal cryptographic key generator 10 is configured to establish the data transfer link to connect with the cryptographic processor 30 via a communication protocol. Such communication protocols may include but is not limited to short-range wireless communication protocols such as Bluetooth, WiFi, Near Field Communication, ZigBee, Z-Wave, IrDA, ANT, RFID or any combination thereof. It is important that the personal cryptographic key generator 10 is configured to operate entirely in an offline mode with the exception of a single instance where the personal cryptographic key generator 10 is switched to an online mode, which the data transfer link is established, to transmit the generated ephemeral keys and/or the signed credentials, and after which the personal cryptographic key generator 10 switches back to the offline mode. By keeping the personal cryptographic key generator 10 in the offline mode, it reduces the attack surface and potential vulnerabilities that could be exploited by attackers to steal or manipulate the ephemeral keys and signed credentials. Furthermore, the personal cryptographic key generator 10 also operates in an unbalance communication mode where the personal cryptographic key generator 10 exclusively initiates and/or disconnects the data transfer link. The unbalance communication mode allows the personal cryptographic key generator 10 to determine when and how data is transmitted. In addition to that, the transmission module may further comprise a counterparty cryptography processor to ensure the operations of the personal cryptographic key generator 10 are performed securely and cannot be intercepted or compromised. The counterparty cryptography processor is mainly used in the setup phrase of every communication link between the personal cryptographic key generator 10 and the cryptographic processor 30 to verify identities and provide protection for the personal cryptographic key generator 10 from unauthorized access or interception.

Preferably, the personal cryptographic key generator 10 may comprise one or more input means for receiving input data from the user. The operations of generating the ephemeral keys and signing credentials can then be activated upon receiving the input data from the user. Such input means may include but is not limited to physical buttons, touch screen, accelerometer, camera, microphone, scanner, and biometric sensor. By way of example, the personal cryptographic key generator 10 includes a biometric sensor as the input means to capture biometric traits of the user. In this example, the personal cryptographic key generator may further comprise a processor for verifying an identity of the user using a template-free biometric authentication algorithm. Upon successful verification of the user, the personal cryptographic key generator 10 will then generate and sign the ephemeral keys and credentials respectively. Preferably, the template-free biometric authentication analyzes raw biometric data captured from the user during the authentication process and use machine learning algorithms or deep learning techniques to analyze the biometric traits and determine whether they match previous instances of the same trait that were previously captured from the same user.

Preferably, the personal cryptographic key generator 10 can include a battery that is not chargeable or replaceable for an extended period of time. Once the personal cryptographic key generator 10 is out of power, the personal cryptographic key generator 10 can be returned to the service provider for a replacement of a new personal cryptographic key generator. Nevertheless, it should be understood that the non-chargeable or replaceable battery can be easily replaced by a rechargeable battery. In this example, it can be charge wirelessly or a charging port can be provided so that the rechargeable battery can be recharged by an external power supply. The charging port can be any type of charging port, such as a wireless charging port or a wired charging port. It should be understood that the charging port may change as technology advances. Different power modes can be implemented by either the power supply or the processor to optimize power consumption and extend the battery life. Preferably, the power modes may include an active mode where all components of the personal cryptographic key generator 10 are fully powered or operated at full capacity, and a sleep mode where some components are disabled or power supply to those components are being reduced/minimized. By way of example, the personal cryptographic key generator 10 may switch to the active mode when a present of biometric is detected by the biometric sensor and switch to the sleep mode after the generated ephemeral keys and/or the signed credentials are transmitted to the cryptographic processor.

In one specific example, the components of the personal cryptographic key generator 10 can be embedded into any NFC bank card, thereby eliminating the need for users to carry an additional device beyond their usual possessions. This implementation can include a touch button and/or fingerprint reader on the NFC bank card. In addition to the conventional scan and pay method, the user may be required to press the touch button or authenticate their identity via the fingerprint before the completion of the transaction.

The user interface 20 can be located on either the client device or the service provider's servers. A client device is a type of computer hardware that accesses the service provider servers via a network communication. Examples of the client device may include but is not limited to portable media player, cellular telephone, pocket-sized personal computer, personal digital assistants (“PDAs”), smartphone, desktop computer, laptop computer, and tablet computer. The client device may also include control circuitry, storage, memory, communications circuitry, input and/or output interfaces as well as any of the additional features. The network communication can be a wireless network connection established via a wireless protocol cloud such as Long-Term Evolution (LTE) cloud, Code Division Multiple Access (CDMA) and its derivatives, Enhanced Data Rates for GSM Evolution (EDGE), 3G protocol, High Speed Packet Access (HSPA), 4G protocol, 5G protocol and the like, in accordance to the advancement of wireless technology with time. The network communication can also be a wired network in which the communication is established through a local network port.

Depending on the setup, the user interface 20 may be in the form of a web browser application hosted by the service provider servers or a dedicated software application that is installed on the client device. The user interface 20 allows users to interact with the service provider servers to complete the login and operation procedures. The interaction may include but not limited to receive input from, and display output to, the user. The user interface 20 may be integrated with a plurality of buttons, icons, or widgets and being arranged in a manner where the users can easily access to the operations provided by the service provider servers. Each button, icon, or widget can be linked to their designated module for commencing their designated operations.

The cryptographic processor 30 is a specialized component that is embedded within the user interface 20. If the user interface 20 is in the form of a software application installed on the client device, then the cryptographic processor 30 will also be installed on the client device as a separate component. On the other hand, the cryptographic processor 30 may also be embedded within the service providers' servers, particularly when the user interface 20 is accessed through a web browser application hosted by the service provider servers. Preferably, the cryptographic processor 30 is whitelisted on the certificate authority server 60 to ensure that only authenticated and authorized application can access the service provider servers.

At most times, the cryptographic processor 30 remains in a dormant state until it receives instructions or calls from the user interface 20 or the software application. The cryptographic processor 30 then challenges and verifies the authenticity of the instructions from the user interface 20 or the software application before triggering an instruction to the user interface 20 or the software application to visually or by audio request for the ephemeral keys or the signed credential from the personal cryptographic key generator 10. In one embodiment, the cryptographic processor 30 can be configured to operate with more than one user interfaces 20 or software applications. Using a single cryptographic processor 30 to operate multiple applications is a cost-effective and efficient approach that can improve system performance, reduce power consumption, and simplify maintenance. With a single cryptographic processor 30, resources can be allocated efficiently between different applications, providing greater flexibility to switch between them as per the user's requirement. This approach reduces the complexity of the system, making it easier to maintain and troubleshoot in case of any issues. Once the personal cryptographic key generator 10 generates the ephemeral keys and transmits to the cryptographic processor 30, the cryptographic processor 30 then performs multiple cycles of salted hash and cryptographic signature operations, using appropriate cryptographic primitives that meet the required levels of complexity and latency. The cryptographic processor 30 will then send the final signed credential to the associated verification processor 40. The cryptographic processor 30 also signs individual or batched lots of instructions, contents such as JSON Certificates, datasets, documents, audio and video files, and sends them to the relevant verification processor 40 at the server provider services. The cryptographic processor 30 may also communicate with the verification processor 40 via encrypted and authenticated channels, and performs the slave role in unbalanced communication mode of the personal cryptographic key generator 10.

Preferably, the service provider servers are operated by one or more service providers. The service providers generally fall into spectrum of catagories based on the following impact considerations: 1) Availability, 2) Severity, 3) Sensitivity normally rated as Low, Medium, High, Critical or rated by a weighted graphical scale. Therefore, if a service provider's impact levels of all 3 considerations are Low, then they can deploy adequate minimum level of security defence. However, if a service provider's impact levels of all 3 considerations have one or more Medium, then they have to balance their mitigation levels with acceptable convenience and cost. Finally, if a service provider's impact levels of all 3 considerations have one or more are High and/or Critical, then it is imperative that they deploy highest level of security strategy that match their Risk management requirements. Examples of such Service Providers can be financial institutions or government institutions. The financial institutions may include but are not limited to commercial banks, investment banks, credit unions, insurance companies, and brokerage firms. The government institutions may include but are not limited to legislative bodies, central banks, regulatory agencies, and public service agencies. Depending on the nature of the service providers, the services offered by the different service providers may vary. It should be noted that some functions of the service provider servers can be easily carried out by the software application due to the advancement of technology. Therefore, the service provides servers can be categorised into local servers or remote servers but they are assumed to be trusted as they are whitelisted with the certification authority server 60. Preferably, the user database is managed by the service provider server as the user database contains information about the user including the user personal details, account information, transaction history and other sensitive information. Further information relating to the generated ephemeral keys and signed credentials by the personal cryptographic key generator 10, and signed credentials and instructions from the cryptographic processor 30 are also stored in the user database. Such further information will be paired with user information of that particular user.

The verification processor 40 is embedded within the service provider servers and it is designed to work in tandem with the cryptographic processor 30. In general, the verification processor 40 retrieves the verification key from the user database or initiate an insertion process to insert the verification key into the user database during a user onboarding process. The verification processor 40 remains idle until a service request is received from the cryptographic processor 30. Upon receiving the request, the verification processor 40 then retrieves the relevant keys from the user database and processes it with an algorithm to generate the appropriate single-use verification key to verify the signature of signed credential received from the cryptographic processor 30.

The device registry server 50 is responsible for the management and verification of the personal cryptographic key generator device 10. The device registry server 50 functions as the custodian of the personal cryptographic key generator 10 certificates and it contains the unique identity of the personal cryptographic key generator 10. During the user onboarding process, the device registry server 50 verifies the personal cryptographic key generator 10 of each new user to ensure that it is valid. This helps to prevent fraudulent use of the personal cryptographic key generator 10 and ensures that the genuine personal cryptographic key generator 10 are used by all users are properly authenticated before gaining access to the service operations provided by the service provider servers.

The certificate authority server 60 is responsible for issuing digital certificates that are used to authenticate the user interface 20 or the software application installed on the client device. These digital certificates contain information about the user interface 20 or the software application. In addition, the certificate authority server 60 also manages the lifecycle of the digital certificates, including renewals and revocations.

The login and operation procedure typically includes three stages: a user onboarding process, a user login process, and an operational process. The computer-implemented protocol for establishing a momentary trust zone may differ between the different stages of the login and operation procedure.

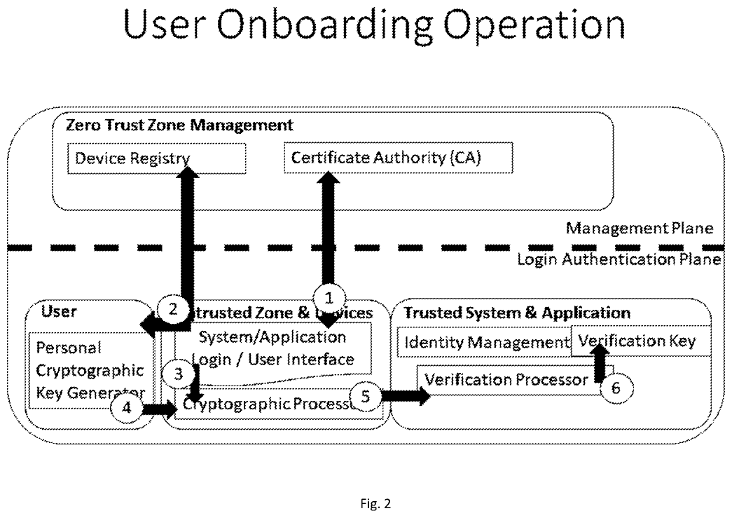

Referring to FIG. 2, the user onboarding process of the login and operation procedure is illustrated. In the first step, after successful download and installation of the software application, the user interface 20 or the software application connects to the embedded cryptographic processor 30, the cryptographic processor 30 then connects to the certificate authority server 60 to obtain a signed certificate. In the second step, the QR code of the personal cryptographic key generator 10 is scanned to obtain the unique identity of the personal cryptographic key generator 10. The cryptographic processor 30 then forwards the unique identity to the device registry server 50 for verifying the personal cryptographic key generator 10. In the third step, the cryptographic processor 30 registers the user interface 20 or the software application′ signed credential verification key. In the fourth step, the user interface 20 instructs the user to activate the personal cryptographic key generator 10. Upon activation, the personal cryptographic key generator 10 generates the ephemeral keys and/or signs the credentials. Followed by transmitting the generated ephemeral keys and/or the signed credentials to the cryptographic processor 30. In the fifth step, the cryptographic processor 30 forwards generated ephemeral keys and/or the signed credentials to the verification processor 40. In the sixth step, the verification processor 40 verifies the received data and then executes an insertion of the verification key that binds with that particular user profile.

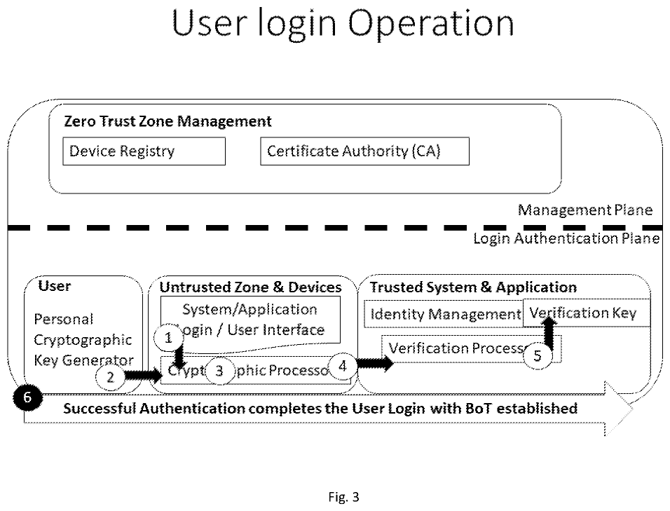

Referring to FIG. 3, the user login process of the login and operation procedure is illustrated. In the first step, the user interface 20 receives login credential of the user to initiate the user login process. The login credential may include user account ID and password. The user interface 20 then displays an instruction to the user to activate the personal cryptographic key generator 10. In the second step, the user activates the personal cryptographic key generator 10 to generate the ephemeral keys and/or sign the credentials. The activation can be a simple button press on the personal cryptographic key generator if password is entered during login. The activation can also be the user scans their biometrics on the biometric sensor of the personal cryptographic key generator 10 and thereby generating the ephemeral keys and/or credential signing upon successful authentication and verification of the user. Followed by transmitting the generated ephemeral keys and/or the signed credentials to the cryptographic processor 30. In the third step, the cryptographic processor 30 processes the data received from the user interface 20 and the personal cryptographic key generator 10. Such processing involves cryptographic processor 30 perform multiple cycles of Salted Hash and cryptographic signature operations done by combinations of appropriate cryptographic primitives that meets the required levels of complexity and latency with the ephemeral keys. In the fourth step, the cryptographic processor 30 transmits the processed data to the verification processor 40. In the fifth step, the verification processor 40 retrieves the relevant keys of that particular user from the user database and processes it with an algorithm to generate the appropriate single-use verification key to verify the signature of signed data received from the cryptographic processor 30. The momentary trust zone is established when the processed data is authenticated and verified by the verification processor 40. Once the momentary trust zone is established, the user interface 20 or the software application can then access to the functional operations provided by the service provider servers.

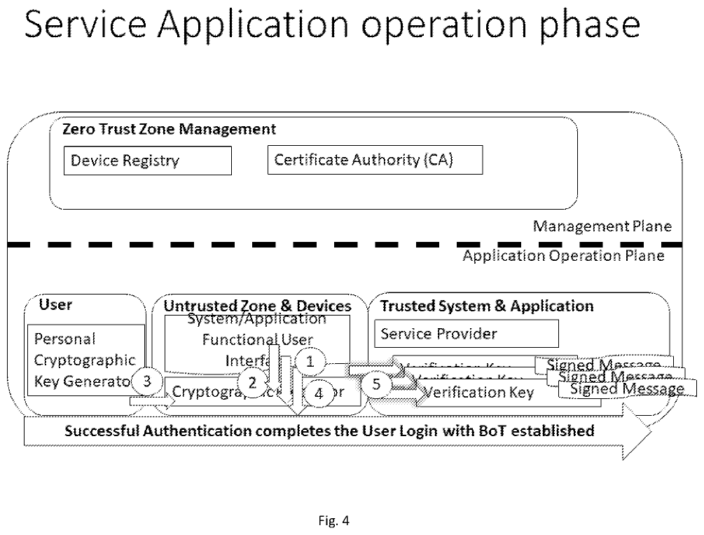

Referring to FIG. 4, the operation process of the login and operation procedure is illustrated. In the first step, the user interface 20 or the software application provides functional options for the user to select and execute upon successful establishment of the momentary trusted zone. This part of the operation can be configured for single function operation or a batch of multiple functions to be collectively signed. In the second step, the cryptographic processor 30 instructs the user interface to request for activating the personal cryptographic key generator 10 upon receiving one or more instruction messages of the function options which required signatures from the user interface 20. In the third step, the user activates the personal cryptographic key generator 10 to generate the ephemeral keys and/or sign the credentials. Followed by transmitting the generated ephemeral keys and/or the signed credentials to the cryptographic processor 30. Preferably, new ephemeral keys are generated by personal cryptographic key generator 10 for each signing operation and transmits to the cryptographic processor 30. In the fourth step, the cryptographic processor 30 performs signature signing on the instruction messages. If the operation is configured for batch signing, then the cryptographic processor 30 performs cascading signature operation to sign a batch of instruction messages. In the fifth step, the cryptographic processor 30 transmits the signed instruction messages, the signature, and a newly generated verification key to the service provider servers. By way of example, the operation process can be further used to conduct signing of digital documents such as contracts, invoices, financial statements, intellectual property documents, HR documents, medical records, legal documents, government forms, academic transcripts, real estate documents, e-commerce transactions, cryptographic transactions as Smart Contracts, DeFi, and Web 3, NFT and any other future cryptographic based derivatives.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1. A computer implementable protocol for establishing a momentary trust zone as part of a login and operation procedure which includes a user onboarding process, a user login process, and an operation process, the protocol, during a user login process, comprising the steps of:
receiving, by a user interface login credential of a user to initiate the login process; instructing, by the user interface the user to activate a personal cryptographic key generator;
performing, by the personal cryptographic key generator, an ephemeral key generation and/or credentials signing upon activation by the user;
transmitting, by the personal cryptographic key generator the newly generated ephemeral keys and/or signed credentials to a cryptographic processor which is embedded within the user interface
processing, by the cryptographic processor, data received from the user interface and the personal cryptographic key generator; and
transmitting, by the cryptographic processor, the processed data to a verification processor which is embedded within the service provider servers;
whereby the momentary trust zone is established when the processed data is authenticated and verified by the verification processor
wherein the personal cryptographic key generator is configured to: (a) operate entirely in an offline mode with the exception of a single instance where the personal cryptographic key generator is switched to an online mode to transmit the generated ephemeral keys and/or the signed credentials, and after which it switches back to the offline mode; and (b) operate in an unbalance communication mode where the personal cryptographic key generator exclusively initiates and/or disconnects a data transfer link to a device which the user interface is operated thereon; and
wherein the cryptographic processor is configured to (a) perform an encryption and/or decryption on the received data to ensure data confidentiality, (b) perform a data integrity checking algorithm on the received data, and (c) perform signatures signing on the user interface credential to authenticate and verify the user interface

2. The computer implementable protocol according to claim 1, wherein the protocol, during the user onboarding process, comprises the steps of:
retrieving, by the cryptographic processor, a signed certificate from a certificate authority server;
receiving, by the user interface a unique identity of the personal cryptographic key generator to verify with a device registry server;
registering, by the cryptographic processor the user interface' (20) signed credential verification key;
instructing, by the user interface the user to activate the personal cryptographic key generator;
performing, by the personal cryptographic key generator, an ephemeral key generation and/or credentials signing upon activation by the user;
transmitting, by the personal cryptographic key generator, the generated ephemeral keys and/or signed credentials to the cryptographic processor;
forwarding, by the cryptographic processor, a verification key of the personal cryptographic key generator to the verification processor; and
binding, by the verification processor, the verification key with the user's profiles.

3. The computer implementable protocol according to claim 1, of wherein the protocol, during the operation process, comprises the steps of:
providing, by the user interface, functional options for the user to select and execute upon successful establishment of the momentary trusted zone;
instructing, by the cryptographic processor, the user interface to request for activating the personal cryptographic key generator upon receiving one or more instruction messages of the function options which required signatures from the user interface; instructing, by the user interface the user to activate the personal cryptographic key generator;
performing, by the personal cryptographic key generator, an ephemeral key generation and/or credentials signing upon activation by the user;
transmitting, by the personal cryptographic key generator, the newly generated ephemeral keys and/or signed credentials to the cryptographic processor;
performing, by the cryptographic processor signature signing on the instruction messages; and
transmitting, by the cryptographic processor the signed instruction messages, the signed credential, and a newly generated verification key to the verification processor

4. The computer implementable protocol according to claim 1, wherein the personal cryptographic key generator comprises a physical isolation arrangement for protecting it physically against unauthorised access and a counterparty cryptography processor to establish the data transfer link in a secure fashion via one or more cryptographic protocols.

5. The computer implementable protocol according to claim 1, wherein the personal cryptographic key generator comprises a notifier to provide a notification of a current operation status.

6. The computer implementable protocol according to claim 1, wherein the personal cryptographic key generator comprises one or more input means for receiving input data from a user.

7. The computer implementable protocol according to claim 6, wherein the one or more input means is in the form of one or more biometric sensors for capturing biometric traits of a user and a processor for verifying an identity of the user using a template-free Artificial Intelligent driven biometric authentication method, whereby the ephemeral keys and credentials are respectively generated and signed upon successful verification of the user.

8. The computer implementable protocol according to claim 1, wherein the generated ephemeral keys and/or signed credentials are of a predetermined structure and size for them to be transmitted in a consistent and secure manner.

9. The computer implementable protocol according to claim 1, wherein the credential is signed using one or more hashing algorithms.

10. The computer implementable protocol according to claim 2, wherein the personal cryptographic key generator comprises a QR code that contains the unique identity of the personal cryptographic key generator, and the unique identity is retrievable through scanning the QR code.

11. The computer implementable protocol according to claim 3, wherein cryptographic processor is configured to perform a cascading signature operation that signs a batch of instruction messages.
